(19) United States
(12) Patent Application Publication
(10) Pub. No.: US 2026/0268007 A1
(43) Pub. Date: Sep. 10, 2026

(54) INFORMATION PROCESSING METHOD, INFORMATION PROCESSING SYSTEM, AND RECORDING MEDIUM

(71) Applicant: Panasonic Intellectual Property Management Co., Ltd., Osaka (JP)

(72) Inventors: Takeru KOIE, Saitama (JP); Kakuya YAMAMOTO, Hyogo (JP); Yuji UNAGAMI, Osaka (JP)

(21) Appl. No.: 19/656,614

(22) Filed: Apr. 23, 2026

Related U.S. Application Data
(63) Continuation of application No. PCT/JP2024/037207, filed on Oct. 18, 2024.
(60) Provisional application No. 63/546,355, filed on Oct. 30, 2023.

(51) Int. Cl. G06F 21/62

(52) U.S. Cl. CPC G06F 21/6218

(57) ABSTRACT

An information processing method to be executed by an information processing system includes: obtaining feature information indicating a feature of each of a plurality of distributed ledger systems; obtaining data held by a user; obtaining a condition requested by the user as a condition that must be satisfied by, and is related to a feature of, a distributed ledger system in which the data is to be stored; selecting, from among the plurality of distributed ledger systems, one or more distributed ledger systems that satisfy the condition; and executing a storage process of storing, in the one or more distributed ledger systems selected, transaction data including the data.

### CROSS REFERENCE TO RELATED APPLICATIONS

This is a continuation application of PCT International Application No. PCT/JP2024/037207 filed on Oct. 18, 2024, designating the United States of America, which is based on and claims priority of U.S. Provisional Patent Application No. 63/546,355 filed on Oct. 30, 2023. The entire disclosures of the above-identified applications, including the specifications, drawings and claims are incorporated herein by reference in their entirety.

### FIELD

The present disclosure relates to an information processing method, an information processing system, and a recording medium.

### BACKGROUND

Distributed ledger technologies such as blockchain have been known.

A method for generating a blockchain transaction and storing the blockchain transaction in a blockchain is disclosed (see PTL 1).

### CITATION LIST

### Patent Literature

PTL 1: Japanese Unexamined Patent Application Publication (Translation of PCT Application) No. 2022-508138

### SUMMARY

### Technical Problem

A plurality of distributed ledgers may be used to store data.

In this case, it may be difficult for a user to judge which of a plurality of distributed ledgers is appropriate to store data that the user wants to store in a distributed ledger.

The present disclosure provides an information processing method and the like that contribute to storing data in an appropriate distributed ledger among a plurality of distributed ledgers.

### Solution to Problem

An information processing method according to an aspect of the present disclosure is an information processing method to be executed by an information processing system, the information processing method including: obtaining feature information indicating a feature of each of a plurality of distributed ledger systems; obtaining data held by a user; obtaining a condition requested by the user as a condition that must be satisfied by, and is related to a feature of, a distributed ledger system in which the data is to be stored; selecting, from among the plurality of distributed ledger systems, one or more distributed ledger systems that satisfy the condition; and executing a storage process of storing, in the one or more distributed ledger systems selected, transaction data including the data.

Note that these general and specific aspects may be implemented using a system, a device, an integrated circuit, a computer program, or a computer-readable recording medium such as a compact disc read-only memory (CD-ROM), or any combination of systems, devices, integrated circuits, computer programs, and computer-readable recording media.

### Advantageous Effects

The present disclosure contributes to storing data in an appropriate distributed ledger among a plurality of distributed ledgers.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating the general configuration of an information processing system in an embodiment.

FIG. 2 is a block diagram illustrating a first example of the functional configuration of a ledger server in an embodiment.

FIG. 3 is a block diagram illustrating a second example of the functional configuration of a ledger server in an embodiment.

FIG. 4 is a block diagram illustrating an example of the functional configuration of a management system in an embodiment.

FIG. 5 is a flowchart illustrating a first example of the processing by a management system in an embodiment.

FIG. 6 is an explanatory diagram showing a first example of feature information in an embodiment.

FIG. 7 is an explanatory diagram showing an example of data in an embodiment.

FIG. 8 is a flowchart illustrating a second example of processing by a management system in an embodiment.

FIG. 9 is an explanatory diagram showing an example of information in an embodiment held by a user.

FIG. 10 is an explanatory diagram showing an example of information to be stored in a distributed ledger in an embodiment.

FIG. 11 is a sequence diagram illustrating a first example of processing by an information processing system in an embodiment.

FIG. 12 is a sequence diagram illustrating a second example of processing by an information processing system in an embodiment.

FIG. 13 is a sequence diagram illustrating a third example of processing by an information processing system in an embodiment.

FIG. 14 is an explanatory diagram showing an example of information stored in a distributed ledger in an embodiment.

FIG. 15 is an explanatory diagram showing a second example of feature information in an embodiment.

FIG. 16 is a flowchart illustrating a first example of processing by a management system in a variation of an embodiment.

FIG. 17 is a flowchart illustrating a second example of processing by a management system in a variation of an embodiment.

FIG. 18 is a sequence diagram illustrating a first example of processing by an information processing system in a variation of an embodiment.

FIG. 19 is a sequence diagram illustrating a second example of processing by an information processing system in a variation of an embodiment.

FIG. 20 is an explanatory diagram illustrating a data structure of a blockchain, which is an example of a distributed ledger.

FIG. 21 is an explanatory diagram illustrating a data structure of transaction data.

FIG. 22 is an explanatory diagram illustrating transaction data pertaining to execution of a smart contract.

FIG. 23 is an explanatory diagram illustrating processing pertaining to execution of a smart contract.

FIG. 24 is an explanatory diagram illustrating structures of an NFT and metadata.

### DESCRIPTION OF EMBODIMENT

### Underlying Knowledge Forming Basis of the Present Disclosure

Regarding the distributed ledger technologies described in the "Background" section, the inventors have found the following:

A plurality of distributed ledgers may be used to store data. The plurality of distributed ledgers may differ in feature from one another. Specifically, the plurality of distributed ledgers may differ in a consensus algorithm used to store transaction data, the total number of nodes (in other words, information processing devices) included in each of ledger systems including the distributed ledgers, the type of information that can be stored in each distributed ledger, the speed at which the transaction data is processed, a fee necessary to store a block containing the transaction data in the distributed ledger, or the like.

In this case, it may be difficult for a user to judge which of a plurality of distributed ledgers is appropriate to store data that the user wants to store in a distributed ledger.

For example, it may be difficult for a user to judge which of a plurality of distributed ledgers is capable of storing data that the user wants to store in a distributed ledger or which of the plurality of distributed ledgers is incapable of storing the data.

In the case where data that a user wants to store in a distributed ledger can be stored in a plurality of distributed ledgers, it may be difficult for the user to judge which of the plurality of distributed ledgers satisfies a request from the user when storing the data.

The present disclosure provides an information processing method and the like that contribute to storing data in an appropriate distributed ledger among a plurality of distributed ledgers.

Hereinafter, aspects according to the disclosure of the present Specification will be described by way of example, and advantageous effects and the like achieved by such aspects will be described.

(1) An information processing method to be executed by an information processing system, the information processing method including: obtaining feature information indicating a feature of each of a plurality of distributed ledger systems; obtaining data held by a user; obtaining a condition requested by the user as a condition that must be satisfied by, and is related to a feature of, a distributed ledger system in which the data is to be stored; selecting, from among the plurality of distributed ledger systems, one or more distributed ledger systems that satisfy the condition; and executing a storage process of storing, in the one or more distributed ledger systems selected, transaction data including the data.

According to the above aspect, the information processing system can cause the data held by the user to be stored in the one or more distributed ledger systems satisfying the condition requested by the user. At this time, the information processing system selects, from among the plurality of distributed ledger systems, the one or more distributed ledger systems satisfying the condition requested by the user. As a result, the user need not select the one or more distributed ledger systems satisfying the condition requested by the user on their own. Accordingly, the information processing system can cause data to be stored in an appropriate distributed ledger, without making a user judge which of a plurality of distributed ledgers is appropriate to store the data. As seen from the above, the information processing system contributes to storing data in the appropriate distributed ledger among the plurality of distributed ledgers.

In addition, the information processing system storing data in an appropriate distributed ledger among a plurality of distributed ledgers may succeed in reducing a processing load in information processing compared with the case where the data is stored in an inappropriate distributed ledger among the plurality of distributed ledgers, thus reducing power consumption.

(2) The information processing method according to (1), in which the condition includes a tamper-resistance condition that is a condition requested by the user as a condition related to an index indicating a degree of tamper resistance of the data stored in the distributed ledger system, and in the selecting of the one or more distributed ledger systems that satisfy the condition: for each of the plurality of distributed ledger systems, an index indicating a degree of tamper resistance of data stored in the distributed ledger system is calculated from the feature information obtained; and one or more distributed ledger systems whose indices calculated satisfy at least the tamper-resistance condition are selected as the one or more distributed ledger systems.

According to the above aspect, the information processing system selects the one or more distributed ledger systems in accordance with the condition requested by the user about the tamper resistance of data stored in a distributed ledger system. Accordingly, the information processing system contributes to storing data in an appropriate distributed ledger that satisfies a condition requested by a user about tamper resistance, among a plurality of distributed ledgers.

(3) The information processing method according to (2), in which the index increases with an increase in a total number of a plurality of information processing devices included in the distributed ledger system, or the index increases with a decrease in the largest share of computational power among the plurality of information processing devices included in the distributed ledger system.

According to the above aspect, the information processing system can calculate the index of the tamper resistance of data more easily using the total number of the plurality of information processing devices included in the distributed ledger system or the share of computational power of each of the plurality of information processing devices included in the distributed ledger system. Accordingly, the information processing system contributes more easily to storing data in an appropriate distributed ledger that satisfies a condition requested by a user about tamper resistance, among a plurality of distributed ledgers.

(4) The information processing method according to (1), in which the condition includes a cost condition that is a condition requested by the user as a condition related to a cost required for storing the data in the distributed ledger system, and in the selecting of the one or more distributed ledger systems that satisfy the condition: for each of the plurality of distributed ledger systems, cost information indicating a cost required for storing the data in the distributed ledger system is calculated from the feature information obtained; and one or more distributed ledger systems whose cost information calculated satisfies at least the cost condition are selected as the one or more distributed ledger systems.

According to the above aspect, the information processing system selects the one or more distributed ledger systems in accordance with the condition requested by the user about the cost required for storing the data in a distributed ledger system. Accordingly, the information processing system contributes to storing data in an appropriate distributed ledger that satisfies a condition requested by a user about cost, among a plurality of distributed ledgers.

(5) The information processing method according to (1), in which the executing of the storage process includes generating transaction data including the data obtained, and storing the transaction data generated in the one or more distributed ledger systems selected.

According to the above aspect, the information processing system generates the transaction data containing the data and stores the transaction data in the one or more distributed ledger systems, as the storage process. Accordingly, the information processing system can cause data held by a user to be stored in one or more distributed ledger systems without requiring another information processing device (e.g., a terminal used by the user, etc.) to generate transaction data.

(6) The information processing method according to (5), in which the executing of the storage process further includes: storing, in a storage device, identification information indicating the one or more distributed ledger systems selected, as identification information indicating the one or more distributed ledger systems in which the data is stored; and outputting the identification information stored in the storage device, in response to receiving an identification request for identifying the one or more distributed ledger systems in which the data is stored.

According to the above aspect, the information processing system outputs the identification information indicating the one or more distributed ledger systems in which the data is stored, in response to the identification request for identifying the one or more distributed ledger systems in which the data is stored. Accordingly, the information processing system can notify a user of one or more distributed ledger systems in which data held by the user is stored.

(7) The information processing method according to (1), in which the executing of the storage process includes providing identification information indicating, among the plurality of distributed ledger systems, a distributed ledger system in which the transaction data including the data obtained should be stored.

According to the above aspect, the information processing system outputs the identification information indicating the distributed ledger system in which the data should be stored, as the storage process. Accordingly, the information processing system can cause another information processing device (e.g., a terminal used by the user, etc.) to generate transaction data containing data and store the transaction data in a distributed ledger.

(8) The information processing method according to any one of (1) to (7), further including: obtaining a data request; obtaining, from a plurality of distributed ledgers included in the plurality of distributed ledger systems, one or more conforming data items that are one or more data items satisfying the data request obtained; and providing the one or more conforming data items obtained.

According to the above aspect, the information processing system can obtain, from the distributed ledger systems, the one or more data items satisfying the data request and provide the one or more data items to the user. Accordingly, the information processing system can store data in an appropriate distributed ledger among a plurality of distributed ledgers and provide the stored data in response to a data request.

(9) The information processing method according to (8), in which in the obtaining of the one or more conforming data items, one or more data items that have already been provided by the user and stored in a distributed ledger and that satisfy the data request obtained are provided as the one or more conforming data items from the plurality of distributed ledgers included in the plurality of distributed ledger systems.

According to the above aspect, the information processing system can obtain, from the distributed ledger systems, the one or more data items satisfying the data request among the one or more data items that have already been provided by the user and stored in the distributed ledger system, and can provide the one or more data items satisfying the data request to the user. Accordingly, the information processing system can store data in an appropriate distributed ledger among a plurality of distributed ledgers and provide the stored data in response to a data request.

(10) The information processing method according to (8), in which in the obtaining of the one or more conforming data items, (i) one or more data items that have already been provided by the user and stored in a distributed ledger and that satisfy the data request obtained or (ii) one or more data items that are related to data which has already been provided by the user and stored in a distributed ledger and that satisfy the data request obtained, are provided as the one or more conforming data items from the plurality of distributed ledgers included in the plurality of distributed ledger systems.

According to the above aspect, the information processing system can obtain, from the distributed ledger systems, (i) the one or more data items satisfying the data request among the one or more data items that have already been provided by the user and stored in the distributed ledger system, or (ii) the one or more data items that are related to (i), and can provide the one or more data items satisfying the data request to the user. Accordingly, the information processing system can store data in an appropriate distributed ledger among a plurality of distributed ledgers and provide the stored data in response to a data request.

(11) The information processing method according to any one of (1) to (7), further including: obtaining a data request; obtaining, from a plurality of distributed ledgers included in the plurality of distributed ledger systems, one or more conforming data items that are one or more data items satisfying the data request obtained, and generating processed data by processing the one or more conforming data items obtained; and providing the processed data generated.

According to the above aspect, the information processing system provides statistical data obtained from data that is stored in the distributed ledger systems and satisfies the data request, to the user. Accordingly, the information processing system can provide information indicating the tendency of data items stored in a plurality of distributed ledgers, to a user, while concealing the data items themselves by avoiding the provision of the data items. Accordingly, the information processing system can store data in an appropriate distributed ledger among a plurality of distributed ledgers and provide the tendency of the stored data in response to a data request while concealing the data.

(12) The information processing method according to any one of (1) to (7), further including: obtaining a data request; and providing identification information indicating, among the plurality of distributed ledger systems, one or more distributed ledger systems that include one or more data items satisfying the data request obtained.

According to the above aspect, the information processing system outputs the identification information indicating the one or more distributed ledger systems in which the data should be stored, as the storage process. Accordingly, the information processing system can store data in an appropriate distributed ledger among a plurality of distributed ledgers and provide the data stored in a distributed ledger in response to a data request, via another information processing device (e.g., a terminal used by a user, etc.).

(13) The information processing method according to (1), in which the information processing system that executes the information processing method is included in a terminal used by the user.

According to the above aspect, the information processing system is implemented with the terminal used by the user. As seen from the above, the information processing system contributes to storing data in the appropriate distributed ledger among the plurality of distributed ledgers while operating as the terminal used by the user.

(14) The information processing method according to (1), in which the information processing system that executes the information processing method is included in an information processing device that is included in the plurality of distributed ledger systems, the information processing device including a distributed ledger.

According to the above aspect, the information processing system is implemented with the information processing device including the distributed ledger. As seen from the above, the information processing system contributes to storing data in the appropriate distributed ledger among the plurality of distributed ledgers while operating as the information processing device including the distributed ledger.

(15) An information processing system including: an obtainer that obtains feature information indicating a feature of each of a plurality of distributed ledger systems, obtains data held by a user, and obtains a condition requested by the user as a condition that must be satisfied by, and is related to a feature of, a distributed ledger system in which the data is to be stored; a selector that selects, from among the plurality of distributed ledger systems, one or more distributed ledger systems that satisfy the condition; and a storer that executes a storage process of storing, in the one or more distributed ledger systems selected, transaction data including the data.

According to the above aspect, the same advantageous effects as those provided by the information processing method are provided.

(16) A program for causing a computer to execute the information processing method according to (1).

According to the above aspect, the same advantageous effects as those provided by the information processing method are provided.

Note that these general and specific aspects may be implemented using a system, a device, an integrated circuit, a computer program, or a computer-readable recording medium such as a CD-ROM, or any combination of systems, devices, integrated circuits, computer programs, or computer-readable recording media.

Hereinafter, an exemplary embodiment will be specifically described with reference to the accompanying Drawings.

Note that the exemplary embodiment described below shows a general or specific example. The numerical values, shapes, materials, constituent elements, the arrangement and connection of the constituent elements, steps, the processing order of the steps etc. shown in the following exemplary embodiment are mere examples, and therefore do not limit the present disclosure. Also, among the constituent elements in the following exemplary embodiment, those not recited in any one of the independent claims representing the most generic concepts will be described as optional constituent elements.

### Embodiment

In the present embodiment, an information processing method and an information processing system that contribute to storing data in an appropriate distributed ledger among a plurality of distributed ledgers will be described.

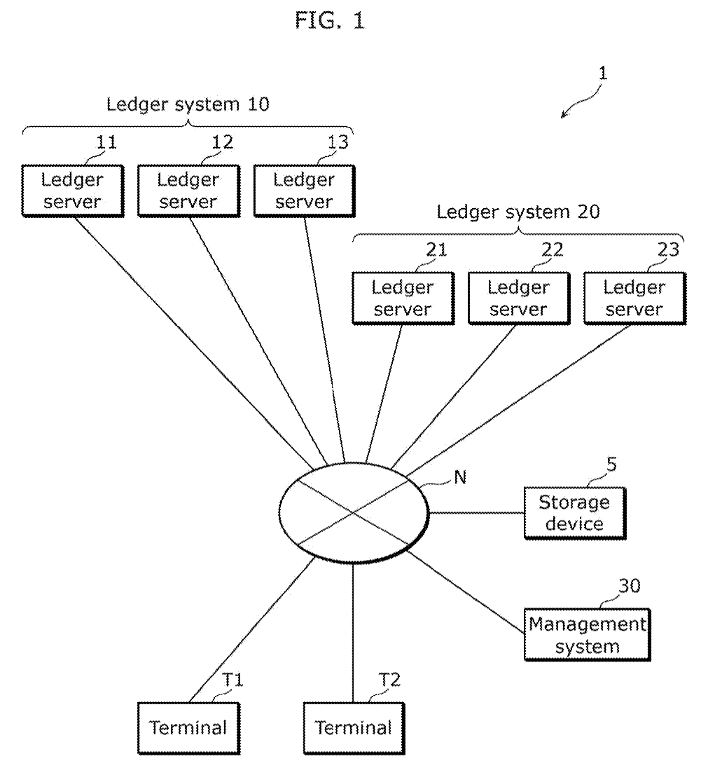

FIG. 1 is a schematic diagram illustrating the general configuration of information processing system 1 in the present embodiment. Information processing system 1 is an example of a system that contributes to storing data in an appropriate distributed ledger among a plurality of distributed ledgers.

As illustrated in FIG. 1, information processing system 1 includes ledger system 10, ledger system 20, and management system 30. Information processing system 1 is connected to storage device 5 and terminals T1 and T2. Note that information processing system 1 may further include storage device 5 or terminal T1 or T2. The above systems and devices are connected to network N, through which they can communicate with each other.

Ledger system 10 is an information processing system that stores information using a distributed ledger (also referred to as a first distributed ledger system). The distributed ledger included in ledger system 10 is capable of storing various types of data. The data to be stored in the distributed ledger included in ledger system 10 can be, for example, the history of generation of a non-fungible token (NFT) associated with an item in the real world, the history of transaction of the NFT, and the like. The NFT can be an NFT with which the generation or transaction of the item in the real world is traced on the distributed ledger (also referred to as a trace NFT).

Using the distributed ledger, ledger system 10 can execute processing under a smart contract. Through the processing executed under the smart contract, ledger system 10 can generate a trace NFT and conduct a transaction of the trace NFT.

Ledger system 10 includes ledger servers 11, 12, and 13 (also referred to as ledger servers 11, etc.), which are a group of servers holding the distributed ledger. When at least one of ledger servers 11, etc. receives transaction data, the transaction data is stored in the distributed ledger and shared by all ledger servers 11, etc. The number of ledger servers in the server group is not limited to three and may be two, or more than three.

Ledger server 11 is a server that is a computer holding and managing the distributed ledger. While maintaining the distributed ledger, ledger server 11 updates the distributed ledger in synchronization with other ledger servers (specifically, ledger servers 12 and 13).

Each of ledger servers 12 and 13 is similar to ledger server 11 and operates independently of ledger server 11.

Ledger system 20 is an information processing system that stores information using a distributed ledger (also referred to as a second distributed ledger system). Ledger system 20 is a system different from ledger system 10. The distributed ledger included in ledger system 20 is also capable of storing various types of data and is also capable of storing the same types of data as the data stored in the distributed ledger included in ledger system 10. In other words, in the case where the data stored in ledger system 10 contains the history of generation, the history of transaction, and the like of a trace NFT, the data stored in ledger system 20 can also contain the history of generation, the history of transaction, and the like of the trace NFT. At this time, an item corresponding to the trace NFT may differ between ledger system 10 and ledger system 20.

Using the distributed ledger, ledger system 20 can execute processing under a smart contract, as with ledger system 10. Through the processing executed under the smart contract, ledger system 20 can generate the trace NFT and conduct the transactions with the trace NFT.

Ledger system 10 and ledger system 20 have different characteristics. Specifically, ledger system 10 and ledger system 20 may differ in feature pertaining to the storing of data or may differ in feature pertaining to a configuration (i.e., the configuration of devices included in each system).

The feature of each of ledger system 10 and ledger system 20 can include, for example, a consensus algorithm used to store transaction data in the distributed ledger, the number of nodes (in other words, information processing devices) included in the ledger system, the type of information that can be stored in the distributed ledger, the speed at which the transaction data is processed, or a fee necessary to store a block containing the transaction data in the distributed ledger.

Ledger system 20 includes ledger servers 21, 22, and 23 (also referred to as ledger servers 21, etc.), which are a group of servers holding the distributed ledger. When at least one of ledger servers 21, etc., receives transaction data, the transaction data is stored in the distributed ledger and shared by all ledger servers 21, etc. Note that the number of ledger servers included in the group of servers is not limited to three and may be two, or more than three.

Ledger server 21 is a server that is a computer holding and managing the distributed ledger. While maintaining the distributed ledger, ledger server 21 updates the distributed ledger in synchronization with other ledger servers (specifically, ledger servers 22 and 23).

Each of ledger servers 22 and 23 is similar to ledger server 21 and operates independently of ledger server 21.

Storage device 5 is a storage device that stores data. Storage device 5 can be accessed (specifically, read from or written to) by ledger system 10 or 20 or terminal T1 or T2 through network N. One or more storage devices 5 may be provided. Information stored in storage device 5 can be used as metadata on an NFT to be generated by ledger system 10 or ledger system 20.

Terminal T1 is an information processing device used by user U1. More specifically, terminal T1 is an information processing device used by user U1 who stores data in ledger system 10 or ledger system 20 using management system 30.

Terminal T1 includes a processor (e.g., a central processing unit (CPU); the same applies hereinafter), a memory, a user interface (e.g., a display screen, a loudspeaker, or a touch panel; the same applies hereinafter), and a communication interface. Terminal T1 can receive input of information using the user interface or the communication interface, and can also generate information, display information, output information as sound, or transmit and receive information. Terminal T1 can be, for example, a personal computer, a tablet, or a smartphone. Details of specific processing performed by terminal T1 will be described later.

Terminal T2 is an information processing device used by user U2. More specifically, terminal T2 is an information processing device used by user U2 who obtains data from ledger system 10 or ledger system 20 using management system 30.

Terminal T2 includes a processor, a memory, a user interface, and a communication interface. Terminal T2 can receive input of information using the user interface or the communication interface, and can also generate information, display information, output information as sound, or transmit and receive information. Terminal T2 can be, for example, a personal computer, a tablet, or a smartphone. Details of specific processing performed by terminal T2 will be described later.

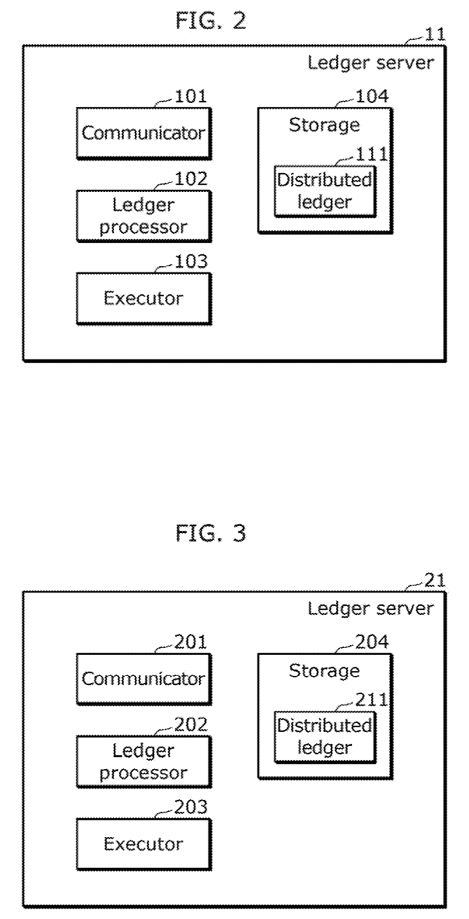

FIG. 2 is a block diagram illustrating the functional configuration of ledger server 11 in the present embodiment.

Ledger server 11 includes, as functional units, communicator 101, ledger processor 102, executor 103, and storage 104. At least some of the functional units of ledger server 11 are implemented by a processor (e.g., a CPU) of ledger server 11 executing a program using a memory.

Communicator 101 is a communication interface communicatively connected to network N. Communicator 101 may be a communication interface based on a wired communication standard, for example, Ethernet (registered trademark), or based on a wireless communication standard, for example, Wi-Fi (registered trademark) or a mobile communication system (e.g., 3rd Generation (3G), 4th Generation (4G), or 5th Generation (5G)). Communicator 101 is used by functional units of ledger server 11 to communicate with other devices.

Ledger processor 102 performs processing related to distributed ledger 111 and transaction data. Specifically, upon receiving transaction data from, for example, ledger system 20 or terminal T1 or T2, ledger processor 102 performs control for verifying a digital signature in the received transaction data and storing the successfully verified transaction data in distributed ledger 111 held in storage 104. To store the transaction data in distributed ledger 111, ledger processor 102 can perform control for generating a block that includes the transaction data to be stored and storing the block in distributed ledger 111 if agreement is made for the generated block with ledger processors 102 of the other ledger servers, i.e., ledger servers 12 and 13.

Executor 103 performs information processing. For example, executor 103 can perform information processing by executing a smart contract using distributed ledger 111. Note that if a smart contract is not used, executor 103 performs information processing according to a normal program code.

As an example of the information processing, executor 103 executes the processing of generating a trace NFT under a smart contract. The trace NFT is associated one-to-one with an item in the real world. The trance NFT includes, as metadata, information containing the type of the item, the quantity of the item, or the like associated with the trace NFT concerned. Details of the metadata in a trace NFT will be described later (see FIG. 7).

Storage 104 is a storage device for storing information. Storage 104 stores distributed ledger 111. Storage 104 is implemented by, for example, a nonvolatile storage device such as a solid-state drive (SSD) or a hard disk drive (HDD).

Distributed ledger 111 stores data structured as chained blocks, each including one or more transaction data items. The one or more transaction data items stored in distributed ledger 111 include transaction data containing the contract code of a smart contract, transaction data containing the instruction to execute a smart contract, or transaction data containing other information.

FIG. 3 is a block diagram illustrating the functional configuration of ledger server 21 in the present embodiment.

Ledger server 21 includes, as functional units, communicator 201, ledger processor 202, executor 203, and storage 204. At least some of the functional units of ledger server 21 are implemented by a processor (e.g., a CPU) of ledger server 21 executing a program using a memory.

Communicator 201 is a communication interface communicatively connected to network N. Communicator 201 may be a communication interface based on a wired communication standard, for example, Ethernet (registered trademark), or based on a wireless communication standard, for example, Wi-Fi (registered trademark) or a mobile communication system (e.g., 3G, 4G, or 5G). Communicator 201 is used by functional units of ledger server 21 to communicate with other devices.

Ledger processor 202 performs processing related to distributed ledger 211 and transaction data. Specifically, upon receiving transaction data from, for example, ledger system 10 or terminal T1 or T2, ledger processor 202 performs control for verifying a digital signature in the received transaction data and storing the successfully verified transaction data in distributed ledger 211 held in storage 204. To store the transaction data in distributed ledger 211, ledger processor 202 can perform control for generating a block that includes the transaction data to be stored and storing the block in distributed ledger 211 if agreement is made for the generated block with ledger processors 202 of the other ledger servers, i.e., ledger servers 22 and 23.

Executor 203 performs information processing. For example, executor 203 can perform information processing by executing a smart contract using distributed ledger 211. Note that if a smart contract is not used, executor 203 performs information processing according to a normal program code.

As an example of the information processing, executor 203 executes the processing of generating a trace NFT under a smart contract. The details of the processing are similar to the processing executed by executor 103.

Storage 204 is a storage device for storing information. Storage 204 stores distributed ledger 211. Storage 204 is implemented by, for example, a nonvolatile storage device such as an SSD or an HDD.

Distributed ledger 211 stores data structured as chained blocks, each including one or more transaction data items. The one or more transaction data items stored in distributed ledger 211 include transaction data containing the contract code of a smart contract, transaction data containing the instruction to execute a smart contract, or transaction data containing other information.

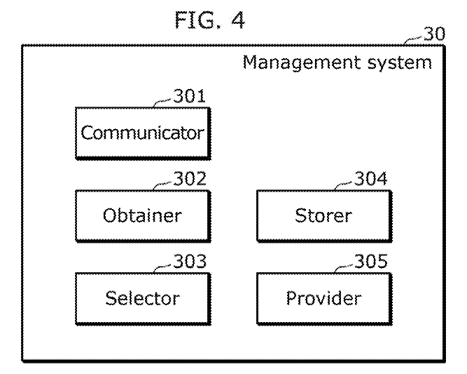

FIG. 4 is a block diagram illustrating an example of the functional configuration of management system 30 in the present embodiment.

As illustrated in FIG. 4, management system 30 includes, as functional units, communicator 301, obtainer 302, selector 303, storer 304, and provider 305. At least some of the functional units of management system 30 are implemented by a processor (e.g., a CPU) of management system 30 executing a program using a memory. Note that management system 30 may be constituted by one information processing device or may be constituted by a plurality of information processing devices.

Communicator 301 is a communication interface communicatively connected to network N. Communicator 301 may be a communication interface based on a wired communication standard, for example, Ethernet (registered trademark), or based on a wireless communication standard, for example, Wi-Fi (registered trademark) or a mobile communication system (e.g., 3G, 4G, or 5G). Communicator 301 is used by functional units of management system 30 to communicate with other devices.

Obtainer 302 obtains information or data. To obtain the information or data, obtainer 302 can use communicator 301 to obtain the information or data. Specifically, obtainer 302 obtains feature information indicating the feature of each of the plurality of ledger systems, data held by user U1, a condition requested by user U1 as a condition that must be satisfied by, and is related to a feature of, a ledger system in which the data is to be stored (simply referred to as "condition"), and the like. Obtainer 302 also obtains a data request. The data request is a request made by user U2 for obtaining data.

Selector 303 selects, from among the plurality of ledger systems, one or more ledger systems that satisfy the condition.

Storer 304 executes a storage process on the data obtained by obtainer 302. The storage process is a process of storing transaction data containing the data obtained by obtainer 302 in the one or more ledger systems selected by selector 303.

Provider 305 obtains, in the case where obtainer 302 obtains the data request, one or more conforming data items that are one or more data items satisfying the obtained data request, from the plurality of distributed ledgers included in the plurality of ledger systems, and provides the one or more obtained conforming data items.

The processing by information processing system 1 configured in the above manner will be described.

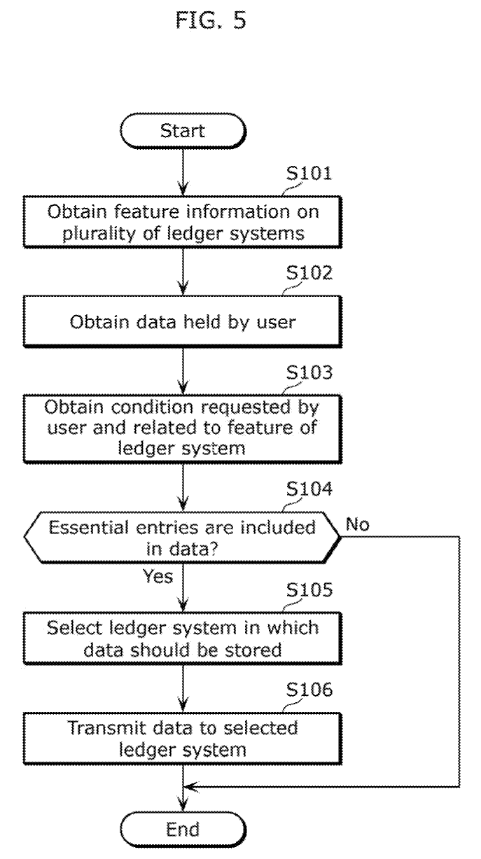

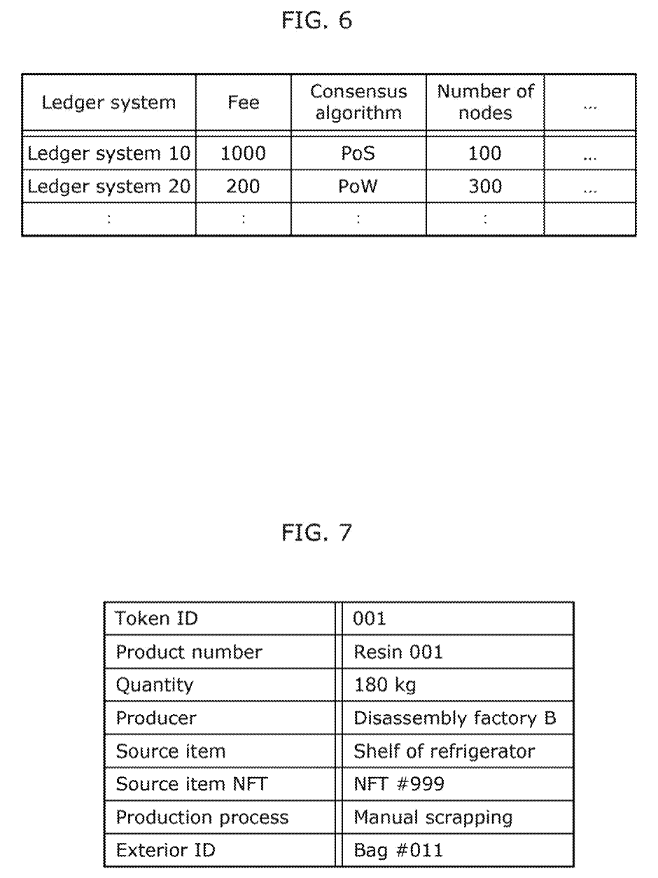

FIG. 5 is a flowchart illustrating a first example of the processing by management system 30 in the present embodiment. FIG. 6 is an explanatory diagram showing a first example of the feature information in the present embodiment. FIG. 7 is an explanatory diagram showing an example of the data in the present embodiment.

The processing illustrated in FIG. 5 is an example of processing executed by management system 30 in the case where user U1 stores the data in ledger system 10 or ledger system 20 using management system 30.

In step S101 illustrated in FIG. 5, obtainer 302 obtains feature information indicating the feature of each of the plurality of ledger systems (specifically, ledger system 10 and ledger system 20). Obtainer 302 may obtain the feature information by obtaining the ledger systems from each of the plurality of ledger systems or may obtain the feature information from another information system.

An example of the feature information is shown in FIG. 6.

The feature information shown in FIG. 6 indicates, for each of ledger system 10 and ledger system 20, a fee necessary to store a block containing transaction data in a distributed ledger, a consensus algorithm to be used to store the transaction data in the distributed ledger, and the number of nodes (in other words, the number of information processing devices) included in the ledger system. Note that the fee is the amount of value information defined for each ledger system. The fee can be expressed in terms of cryptocurrency, legal currency, information (coupon or points) treated as a value equivalent to the above, or the like.

The feature information indicates, for ledger system 10, that the fee is 1000, the consensus algorithm is Proof of Stake (PoS), and the number of nodes is 100.

The feature information indicates, for ledger system 20, that the fee is 200, the consensus algorithm is Proof of Work (PoW), and the number of nodes is 300.

In step S102, obtainer 302 obtains data held by user U1. The data is data that is to be stored now in ledger system 10 or ledger system 20 using management system 30. Obtainer 302 can obtain the data from terminal T1 of user U1. An example of the data can be metadata on a trace NFT (see FIG. 7).

The data shown in FIG. 7 is metadata on a trace NFT that is associated one-to-one with a resin. Note that the resin means a synthetic resin.

The data shown in FIG. 7 contains a token ID, a product number, a quantity, a producer, a source item, a source item NFT, a production process, and an exterior ID.

The token ID is the token ID of the trace NFT concerned (e.g., "001").

The product number indicates the product number of the item associated with the trace NFT concerned (e.g., "Resin 001"). For example, the product number may be a product number given by a party that has produced the item.

The quantity indicates the quantity of the item associated with the trace NFT concerned (e.g., "180kg"). The quantity can be the number of items, the weight, volume, or the like of an item.

The producer is information indicating a party that has produced the item associated with the trace NFT concerned (e.g., "Disassembly factory B").

The source item is information indicating an item from which the item associated with the trace NFT concerned has been produced (e.g., "Shelf of refrigerator"). In other words, the source item indicates that the item associated with the trace NFT concerned has been produced from the item being a source. For example, the source item can be the name of the item from which the item associated with the trace NFT concerned has been produced.

The source item NFT can be the token ID of a trace NFT associated with the item from which the item associated with the trace NFT concerned has been produced.

The production process is information indicating a process through which the item associated with the trace NFT concerned has been produced (e.g., "Manual scrapping").

The exterior ID is identification information that is given to the exterior of the item associated with the trace NFT concerned. For example, the exterior ID may be an ID given by the party that has produced the item. The exterior ID may be the same information as identification information that is given to the exterior of the item in a visible manner. For example, the exterior ID can be information (a number, etc.) provided on the outer surface of a container (e.g., a bag or a box, etc.) that accommodates the item.

Note that metadata on a trace NFT contains data entries that have to be contained in the metadata on the trace NFT (also referred to as essential entries) and data entries that may or need not be contained in the metadata on the trace NFT (also referred to as optional entries). Examples of the essential entries can include quantity, producer, source item, and exterior ID. The optional entries can be the data entries contained in the trace NFT excluding the essential entries.

In step S103, obtainer 302 obtains a condition requested by the user, as a condition that must be satisfied by, and is related to a feature of, a ledger system in which the data is to be stored (also referred to as "condition" or "feature condition").

The condition can include a condition that is a condition requested by the user as a condition related to an index indicating the degree of tamper resistance of the data stored in the ledger system (also referred to as tamper-resistance condition).

The index may be calculated as a value that increases with an increase in the number of a plurality of ledger servers (in other words, information processing devices) included in the ledger system. This is because, if the data stored in the ledger system is to be altered, an increase in the number of the plurality of ledger servers included in the ledger system makes it more difficult to establish consistency of data among blocks, thus making it more difficult to tamper with the data stored in the ledger system.

The index may be calculated as a value that increases with a decrease in the largest share of computational power among the plurality of ledger servers (in other words, information processing devices) included in the ledger system. This is because it is known that data stored in a ledger system can be tampered with in the case where the largest share of computational power among a plurality of ledger servers included in the ledger system is 51% or greater (also referred to as 51% attack). Accordingly, in the case where the largest share of computational power among a plurality of ledger servers included in a ledger system is less than 51%, the smaller the share, the lower the probability that 51% attack will occur, and thus tampering with data stored in the ledger system is more difficult.

The condition can include a cost that is a condition requested by the user as a condition related to a cost required for storing the data in the ledger system (also referred to as cost condition).

Note that the condition may be other than the above. The condition may be priorities for the ledger systems. The priorities for the ledger systems may be priorities that are defined in advance by the user. The priorities for the ledger systems may be defined in accordance with the type of data to be stored. For example, in the case where the type of data to be stored is defined for the ledger system, a high priority may be set for the case where data of the type is stored in the ledger system.

In step S104, selector 303 determines whether the data obtained by obtainer 302 in step S102 contains the essential entries. In the case where selector 303 determines that the data obtained by obtainer 302 in step S102 contains the essential entries (Yes in step S104), selector 303 proceeds to step S105; otherwise (No in step S104), selector 303 terminates the series of steps illustrated in FIG. 5.

In step S105, selector 303 selects, from among the plurality of distributed ledgers, a ledger system in which the data obtained by obtainer 302 in step S102 should be stored. At this time, the data can contain a plurality of data items, which can be separated and stored in a plurality of distributed ledgers. In this case, selector 303 selects, for each of the plurality of separated data items, a ledger system in which the data item should be stored.

To select one or more ledger systems satisfying the condition obtained in step S103 described above in the case where the condition includes the tamper-resistance condition, for each of the plurality of distributed ledger systems 10 and 20, the index indicating the degree of tamper resistance of data stored in the distributed ledger system is calculated from the obtained feature information, and one or more ledger systems whose calculated indices satisfy at least the tamper-resistance condition can be selected.

To select one or more ledger systems satisfying the condition obtained in step S103 described above in the case where the condition includes the cost condition, for each of the plurality of distributed ledger systems 10 and 20, cost information indicating the cost required for storing data in the distributed ledger system is calculated from the obtained feature information, and one or more distributed ledger systems whose calculated cost information satisfies at least the cost condition can be selected.

In step S106, storer 304 transmits the data obtained in step S102 to the ledger system selected by selector 303 in step S105. The transmitted data is supposed to be stored in a ledger system being the destination of the data (i.e., the selected ledger system). The process of step S106 is an example of the storage process of storing transaction data containing the data obtained by obtainer 302 in the one or more ledger systems selected by selector 303.

Note that, in step S106, storer 304 may further store, in the storage device, identification information indicating the one or more selected ledger systems, as identification information indicating the one or more ledger systems in which the data is stored. In this case, storer 304 can output the identification information stored in the storage device, in response to receiving an identification request for identifying the one or more distributed ledger systems in which the data is stored.

Through the series of steps illustrated in FIG. 5, management system 30 can store the data held by the user in ledger system 10 or ledger system 20 in such a manner as to satisfy the condition requested by the user.

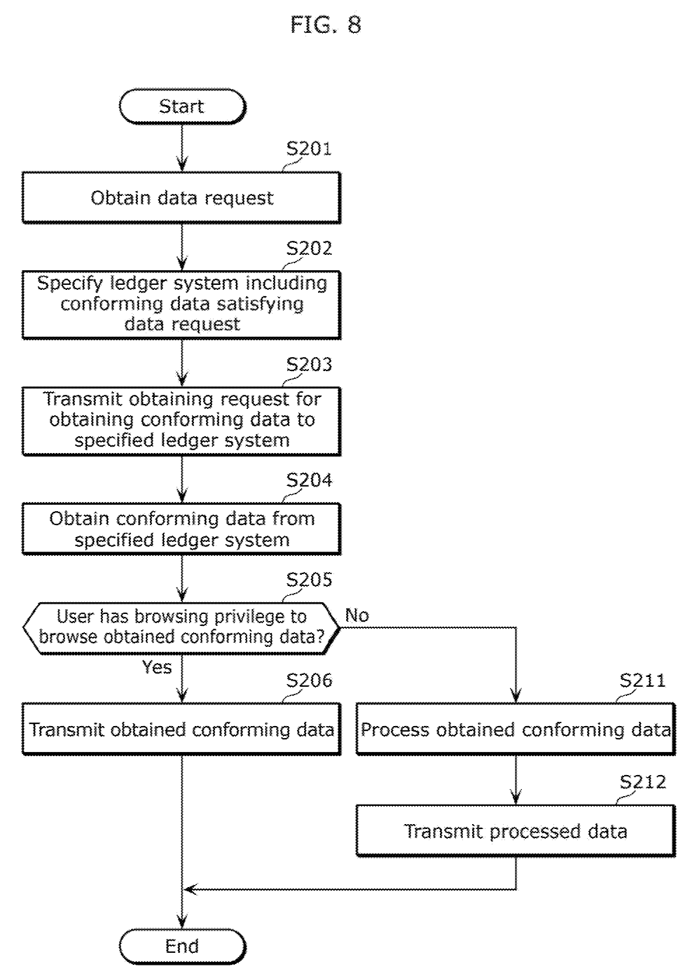

FIG. 8 is a flowchart illustrating a second example of the processing by management system 30 in the present embodiment. The processing illustrated in FIG. 8 is an example of processing executed by management system 30 in the case where user U2 obtains data from ledger system 10 or ledger system 20 using management system 30.

In step S201, obtainer 302 obtains a data request. The obtained data request can be a request that is transmitted by terminal T2 and made by user U2 for obtaining data. The data request includes, for example, "Resin 001" as data on a product number. This indicates a request for obtaining data whose data on the product number is "Resin 001."

In step S202, provider 305 specifies, from the plurality of distributed ledger systems 10 and 20, a ledger system that includes data satisfying the data request obtained in step S201 (also referred to as conforming data).

In step S203, provider 305 transmits an obtaining request for obtaining the conforming data to the ledger system specified in step S202.

In step S204, provider 305 obtains the conforming data from the ledger system specified in step S202. The obtained conforming data can be conforming data that the ledger system receiving the obtaining request transmitted in step S203 reads and transmits from a distributed ledger in response to the obtaining request.

In the case where one or more conforming data items are obtained in step S204 described above, one or more data items that have already been provided by the user and stored in a distributed ledger and that satisfy the obtained data request can be provided as the one or more conforming data items from the plurality of distributed ledgers included in the plurality of distributed ledger systems 10 and 20.

In the case where the one or more conforming data items are obtained in step S204 described above, (i) one or more data items that have already been provided by the user and stored in a distributed ledger and that satisfy the obtained data request or (ii) one or more data items that are related to data which has already been provided by the user and stored in a distributed ledger and that satisfy the obtained data request, may be provided as the one or more conforming data items from the plurality of distributed ledgers included in the plurality of ledger systems, which are ledger system 10 and ledger system 20.

In step S205, provider 305 determines whether user U2 has a browsing privilege to browse the conforming data obtained in step S204. In the case where user U2 has the browsing privilege (Yes in step S205), provider 305 proceeds to step S206; otherwise (No in step S205), provider 305 proceeds to step S211.

In step S206, provider 305 transmits the conforming data obtained in step S204 to terminal T2.

In step S211, provider 305 generates processed data by processing the conforming data obtained in step S203. Here, the processing of the conforming data is the addition of some modification to the conforming data. For example, the processing of the conforming data can be the addition of a modification to reduce the level of detail, accuracy, rigor, or the like of the conforming data. In the case where the conforming data contains one or more numerical data items, the processing of the conforming data can be the performance of statistical processing (the process of calculating a mean value or a median, or a rounding process, etc.) on the one or more numerical data items.

In step S212, provider 305 transmits the processed data generated in step S211 to terminal T2.

Through the series of steps illustrated in FIG. 8, management system 30 can obtain the data satisfying the data request from user U2 from ledger system 10 or ledger system 20 and provide the data to user U2.

Hereinafter, processing performed by information processing system 1 will be described. Here, the processing executed by information processing system 1 in the case where, with user U1 intending to store new data in ledger system 10 or ledger system 20, management system 30 is used to store the new data in ledger system 10 or ledger system 20 after checking data stored in ledger system 10 or ledger system 20 will be described.

Here, distributed ledger 111, which is held by ledger system 10, is assumed to be capable of storing data related to a resin (including a recycled resin). It can be impossible or inappropriate for distributed ledger 111 to store data related to the amount of electricity and the amount of CO₂.

In addition, distributed ledger 211, which is held by ledger system 20, is assumed to be capable of storing data related to the amount of electricity and the amount of CO₂. It can be impossible or inappropriate for distributed ledger 211 to store data related to a resin.

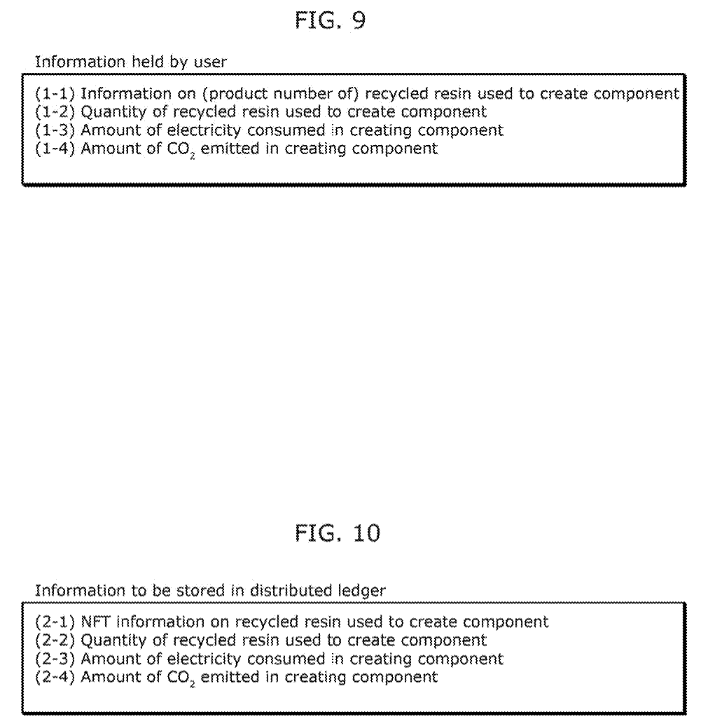

FIG. 9 is an explanatory diagram showing an example of information in the present embodiment held by a user.

The information shown in FIG. 9 contains (1-1) information (product number) of a recycled resin used to create a component, (1-2) the quantity of the recycled resin used to create the component, (1-3) the amount of electricity consumed in creating the component, and (1-4) the amount of CO₂ (carbon dioxide) emitted in creating the component.

FIG. 10 is an explanatory diagram showing an example of information to be stored in a distributed ledger in the present embodiment.

The information shown in FIG. 10 contains (2-1) NFT information on a recycled resin used to create a component, (2-2) the quantity of the recycled resin used to create the component, (2-3) the amount of electricity consumed in creating the component, and (2-4) the amount of CO₂ emitted in creating the component.

Here, the essential entries of data to be stored in the distributed ledger are assumed to be (2-1) NFT information on a recycled resin used to create a component, and (2-2) the quantity of the recycled resin used to create the component.

The difference between FIG. 9 and FIG. 10 is that information (1-1) in FIG. 9, that is, "information (product number) of a recycled resin used to create a component" is different from information (2-1) in FIG. 10, that is, "NFT information on a recycled resin used to create a component."

The information held by the user shown in FIG. 9 does not contain information that falls under information (2-1) and thus cannot be stored in the distributed ledger as it is. This is because the information held by the user shown in FIG. 9 in the distributed ledger needs to contain information falling under information (2-1) in order to be stored in the distributed ledger.

Hence, information processing system 1 first specifies a token ID being NFT information on the recycled resin, using information (1-1), which is the information (product number), of the information held by the user shown in FIG. 9. Information processing system 1 next stores information that contains the specified NFT information (i.e., the token ID) in the distributed ledger, based on the information held by the user shown in FIG. 9.

Hereinafter, the processing performed by information processing system 1 will be described specifically.

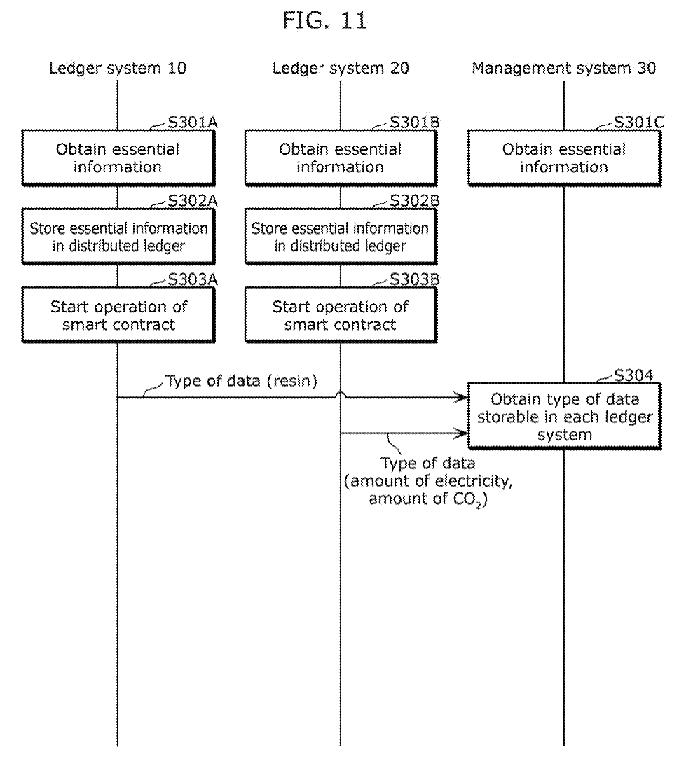

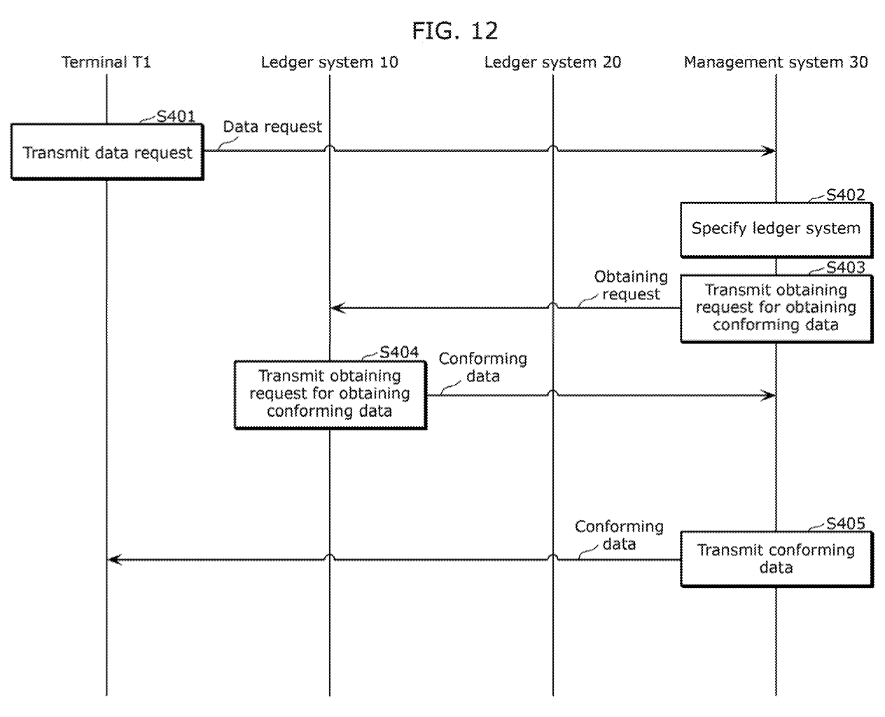

FIG. 11 is a sequence diagram illustrating a first example of the processing by information processing system 1 in the present embodiment. The processing illustrated in FIG. 11 is an example of processing executed by information processing system 1 to bring about the state where management system 30 is ready to execute the storage process of storing data in ledger system 10 or ledger system 20.

In step S301A, ledger system 10 obtains essential information. The essential information is information for specifying the essential entries in the data to be stored in ledger system 10 or ledger system 20. Ledger system 10 can obtain the essential information from, for example, an information management organization that defines the essential entries of the data to be stored in ledger system 10 or ledger system 20.

In step S301B, ledger system 20 obtains essential information. The process in which ledger system 20 obtains the essential information is similar to the process in which ledger system 10 obtains the essential information (step S301A).

In step S301C, management system 30 obtains essential information. The process in which management system 30 obtains the essential information is similar to the process in which ledger system 10 obtains the essential information (step S301A).

In step S302A, ledger system 10 stores the obtained essential information in a distributed ledger.

In step S302B, ledger system 20 stores the obtained essential information in a distributed ledger. The process in which ledger system 20 stores the essential information in the distributed ledger is similar to the process in which ledger system 10 stores the essential information in the distributed ledger (step S302A).

In step S303A, ledger system 10 starts the operation of a smart contract. The smart contract is a smart contract that performs the process of storing data received from terminal T1 or management system 30 in the distributed ledger. In the case where data is received from terminal T1 or management system 30 after the execution of step S303A, ledger system 10 can perform the process of storing the received data in the distributed ledger with the function of the smart contract.

In step S303B, ledger system 20 starts the operation of a smart contract. The process in which ledger system 20 starts the operation of the smart contract is similar to the process in which ledger system 10 starts the operation of the smart contract (step S303A).

In step S304, management system 30 obtains information indicating the types of data that can be stored in distributed ledgers 111 and 211 in ledger system 10 and ledger system 20, respectively. Here, management system 30 obtains information indicating resin, as the type of data that can be stored in distributed ledger 111. Management system 30 also obtains information indicating the amount of electricity and the amount of CO₂, as the type of data that can be stored in distributed ledger 211.

The series of steps illustrated in FIG. 11 brings information processing system 1 into the state where management system 30 is ready to execute the storage process of storing data in ledger system 10 or ledger system 20.

FIG. 12 is a sequence diagram illustrating a second example of the processing by information processing system 1 in the present embodiment. The processing illustrated in FIG. 12 is an example of processing executed by information processing system 1 in the case where management system 30 obtains data from ledger system 10 or ledger system 20 and provides the data to a user.

In step S401, terminal T1 transmits a data request to management system 30. Management system 30 receives the data request (step S201 in FIG. 8). The data request includes "Resin 001" as data on a product number.

In step S402, management system 30 specifies ledger system 10 as a ledger system that includes conforming data satisfying the data request received in step S401 (step S202 in FIG. 8). Based on the fact that distributed ledger 111 held by ledger system 10 stores data related to a resin, management system 30 can specify ledger system 10 as the ledger system including the conforming data.

In step S403, management system 30 transmits an obtaining request for obtaining the conforming data to ledger system 10 specified in step S402. The obtaining request for obtaining the conforming data is a request for obtaining, as the conforming data, data containing "Resin 001" as the data on the product number included in the data request. Ledger system 10 receives the obtaining request for obtaining the conforming data.

In step S404, in response to the obtaining request received in step S403, ledger system 10 reads the conforming data from distributed ledger 111 and transmits the read conforming data to management system 30. The conforming data transmitted by ledger system 10 contains, as an example, metadata on a trace NFT of Resin 001 (see FIG. 7). Management system 30 receives the transmitted conforming data.

In step S405, management system 30 transmits the conforming data received in step S404 to terminal T1. Terminal T1 receives the transmitted conforming data.

As an example, referring to the metadata on the trace NFT of Resin 001, terminal T1 can obtain NFT information on (i.e., the token ID of) the resin whose product number is "Resin 001."

Through the series of steps illustrated in FIG. 12, information processing system 1 can obtain data from ledger system 10 or ledger system 20 and provide the data to a user, with management system 30.

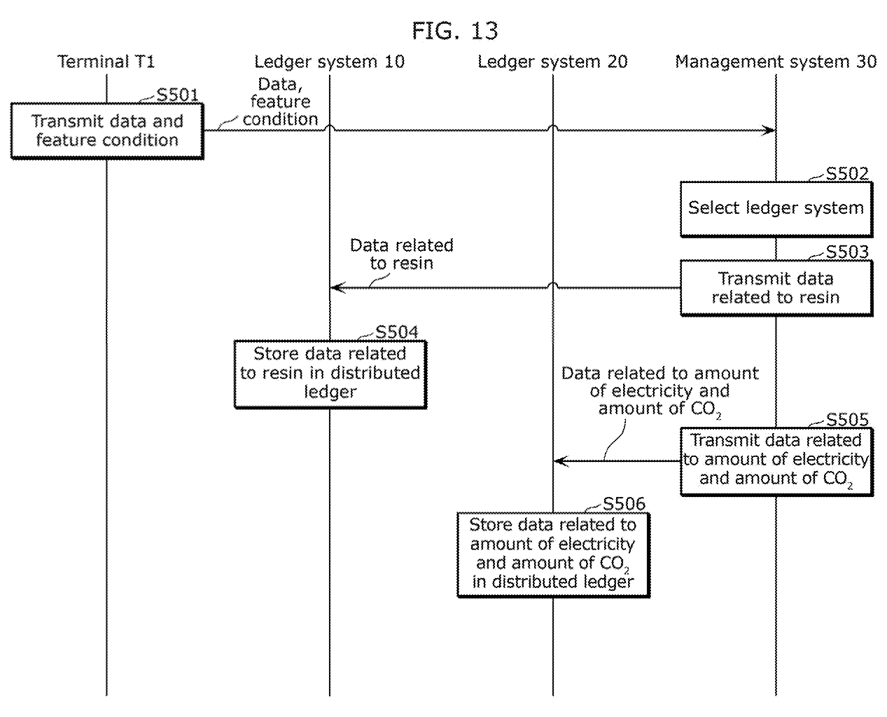

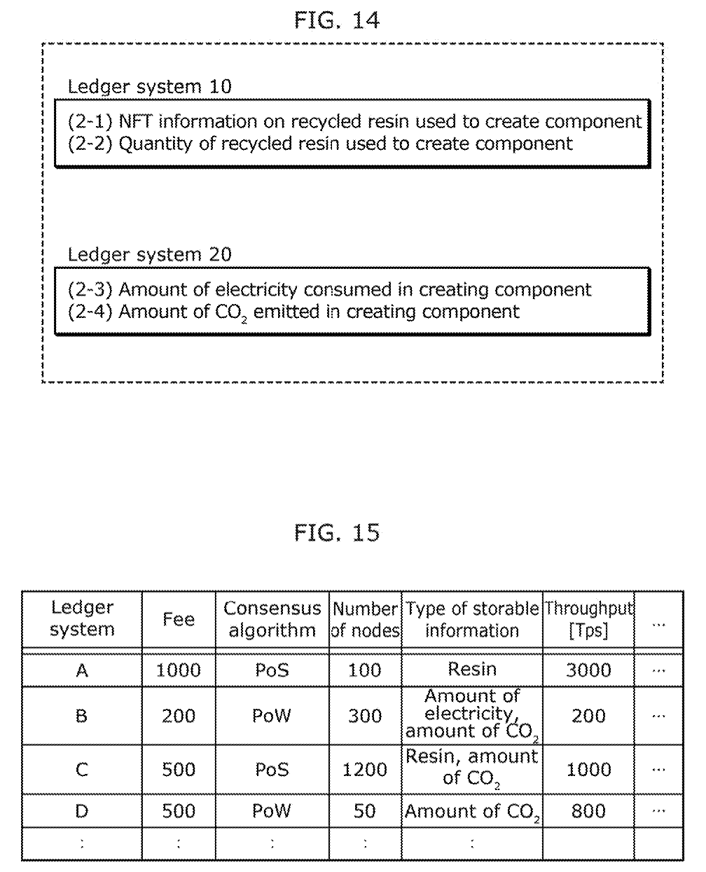

FIG. 13 is a sequence diagram illustrating a third example of the processing by information processing system 1 in the present embodiment. FIG. 14 is an explanatory diagram showing an example of information stored in a distributed ledger in the present embodiment.

The processing illustrated in FIG. 13 is an example of processing executed by information processing system 1 in the case where management system 30 stores data in ledger system 10 or ledger system 20.

In step S501, terminal T1 transmits data and a feature condition to management system 30. The data transmitted by terminal T1 can be data that is information held by a user (see FIG. 9) to which NFT information obtained in step S405 as the conforming data is added. Note that, of the information held by the user (see FIG. 9), information (1-1), which is the information (product number), may be deleted. This case will be described as an example. This is because information (1-1) is not contained in the information to be stored in a distributed ledger (see FIG. 10). The feature condition transmitted by terminal T1 is a condition requested by the user, as a condition that must be satisfied by, and is related to a feature of, a ledger system in which the data is to be stored. Management system 30 receives the transmitted data and feature condition (steps S102 and S103 in FIG. 5).

In step S502, determining that the data received in step S501 contains the essential entries, management system 30 selects a ledger system in which the data should be stored (steps S104 and S105 in FIG. 5). At this time, management system 30 selects ledger system 10, as a ledger system in which data related to a resin (i.e., NFT information on a recycled resin used to create a component and the quantity of the recycled resin used to create the component) should be stored. Management system 30 also selects ledger system 20, as a ledger system in which data related to the amount of electricity and the amount of CO₂ (i.e., the amount of electricity consumed in creating the component and the amount of CO₂ emitted in creating the component) should be stored.

In step S503, management system 30 transmits the data related to the resin to ledger system 10. Ledger system 10 receives the transmitted data related to the resin.

In step S504, ledger system 10 stores the data received in step S503 and related to the resin in distributed ledger 111.

In step S505, management system 30 transmits the data related to the amount of electricity and the amount of CO₂ to ledger system 20. Ledger system 20 receives the transmitted data related to the amount of electricity and the amount of CO₂.

In step S506, ledger system 20 stores the data received in step S505 and related to the amount of electricity and the amount of CO₂ in distributed ledger 211.

At the time when the above steps S504 and S506 are completed, ledger system 10 (more specifically, distributed ledger 111) stores the data related to the resin. In addition, ledger system 20 (more specifically, distributed ledger 211) stores the data related to the amount of electricity and the amount of CO₂ (see FIG. 14).

Through the series of steps illustrated in FIG. 13, information processing system 1 can store data in ledger system 10 or ledger system 20, with management system 30.

Note that data and a feature condition that should be stored in a distributed ledger can vary. Examples of this are as follows.
(1) In the case where the data that should be stored in a distributed ledger is metadata on an NFT, and the feature condition is a high profit (in other words, a small fee), management system 30 can select, as a ledger system in which the NFT is to be stored, ledger system 20, which is a ledger system whose fee is small. It is assumed here that the feature information on ledger system 10 and ledger system 20 is as shown in FIG. 6.
(2) In the case where the data that should be stored in a distributed ledger is data indicating the delivery of environment value, and the feature condition is a low environmental load, management system 30 can select, as a ledger system in which the NFT is to be stored, ledger system 10, which is a ledger system using PoS, a consensus algorithm with a relatively small amount of calculation. It is assumed here that the feature information on ledger system 10 and ledger system 20 is as shown in FIG. 6.
(3) In the case where there are ledger systems A, B, C, and D, the data that should be stored in a distributed ledger is
   (a) information on a resin produced from disassembly,
   (b) the amount of electricity consumed in the disassembly, and
   (c) the amount of CO₂ emitted in the disassembly, and the feature condition is that
      (i) information is stored appropriately,
      (ii) the throughput of the storage process is high, and
      (iii) tamper resistance is high, management system 30 can select ledger system A as a ledger system in which the information on the resin should be stored, select ledger system C as a ledger system in which the information on CO₂ should be stored, and select ledger system B as a ledger system in which the information on the amount of electricity should be stored. It is assumed here that the feature information on ledger systems A, B, C, and D is as shown in FIG. 15. In FIG. 15, the throughput is indicated in terms of the number of transaction data items that can be processed per unit second (Transactions per second).

Note that management system 30 may be included in a terminal used by a user.

Alternatively, management system 30 may be included in a ledger server. In this case, management system 30 includes a distributed ledger. This causes the communication between management system 30 and ledger system 10 or ledger system 20 to be performed inside the device. In other words, this has the advantage of eliminating the need for communication between devices.

### Variation of Embodiment

In the present variation, another example of an information processing method and an information processing system that contribute to storing data in an appropriate distributed ledger among a plurality of distributed ledgers will be described.

In the present variation, management system 30 assists terminal T1 in storing data in ledger system 10 or ledger system 20 or obtaining data from ledger system 10 or ledger system 20, by transmitting identification information indicating ledger system 10 or ledger system 20 to terminal T1, instead of intervening between terminal T1 and ledger system 10 or ledger system 20 for transmitting or receiving the data.

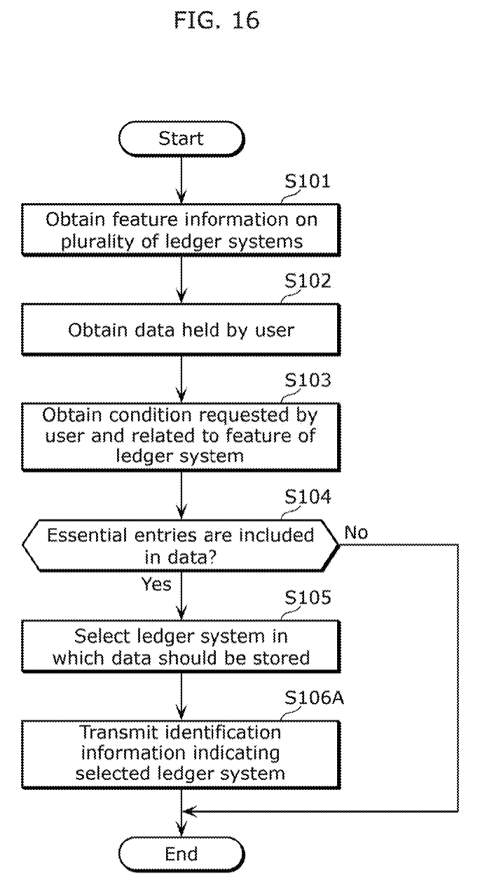

FIG. 16 is a flowchart illustrating a first example of the processing by management system 30 in the variation of the present embodiment. The processing illustrated in FIG. 16 is an example of processing executed by management system 30 in the case where user U1 stores the data in ledger system 10 or ledger system 20 using management system 30.

The processes of step S101 to step S105 illustrated in FIG. 16 are the same as the processes with the same names illustrated in FIG. 5.

In step S106A, storer 304 transmits identification information indicating the ledger system selected by selector 303 in step S105 (i.e., the ledger system in which the data obtained by obtainer 302 in step S102 should be stored) to terminal T1.

Through the series of steps illustrated in FIG. 16, management system 30 can assist in storing the data held by the user in ledger system 10 or ledger system 20 in such a manner as to satisfy the condition requested by the user.

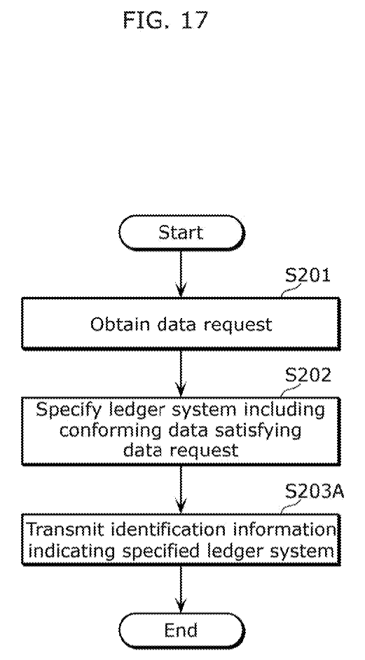

FIG. 17 is a flowchart illustrating a second example of the processing by management system 30 in the variation of the present embodiment. The processing illustrated in FIG. 17 is an example of processing executed by management system 30 in the case where user U2 obtains data from ledger system 10 or ledger system 20 using management system 30.

The processes of step S201 to step S202 illustrated in FIG. 17 are the same as the processes with the same names illustrated in FIG. 8.

In step S203A, provider 305 transmits identification information indicating the ledger system specified in step S202 (i.e., a ledger system including the conforming data satisfying the data request obtained in step S201, among the plurality of distributed ledger systems 10 and 20) to terminal T2.

Through the series of steps illustrated in FIG. 17, management system 30 can assist user U2 in obtaining the data satisfying the data request from user U2 from ledger system 10 or ledger system 20.

The following will describe the processing by information processing system 1 in the case where, with a user intending to store new data in ledger system 10 or ledger system 20, management system 30 is used to store the new data in ledger system 10 or ledger system 20 after checking data stored in ledger system 10 or ledger system 20. Distributed ledger 111 held by ledger system 10 and distributed ledger 211 held by ledger system 20 are similar to those in the embodiment described above.

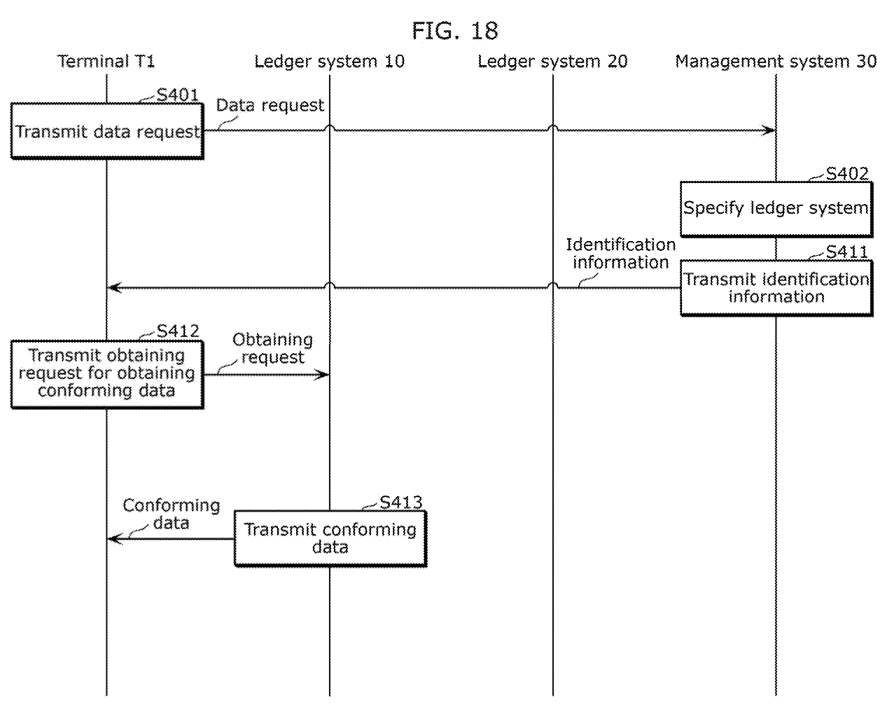

FIG. 18 is a sequence diagram illustrating a first example of the processing by information processing system 1 in a variation of the present embodiment. The processing illustrated in FIG. 18 is an example of processing executed by information processing system 1 in the case where management system 30 obtains data from ledger system 10 or ledger system 20 and provides the data to a user.

The processes of step S401 to step S402 illustrated in FIG. 18 are the same as the processes with the same names illustrated in FIG. 12.

In step S411, management system 30 transmits identification information indicating the ledger system specified in step S402 to terminal T1. The identification information transmitted by management system 30 is identification information indicating ledger system 10. Terminal T1 receives the transmitted identification information.

In step S412, terminal T1 transmits an obtaining request for obtaining conforming data to ledger system 10, which is indicated by the identification information received in step S411. The obtaining request for obtaining the conforming data is a request for obtaining, as the conforming data, data containing "Resin 001" as the data on the product number included in the data request. Ledger system 10 receives the obtaining request for obtaining the conforming data.

In step S413, in response to the obtaining request received in step S412, ledger system 10 reads the conforming data from distributed ledger 111 and transmits the read conforming data to terminal T1. The conforming data transmitted by ledger system 10 contains, as an example, metadata on a trace NFT of Resin 001 (see FIG. 7). Terminal T1 receives the transmitted conforming data.

Through the series of steps illustrated in FIG. 18, information processing system 1 can assist the user in obtaining data from ledger system 10 or ledger system 20, with management system 30.

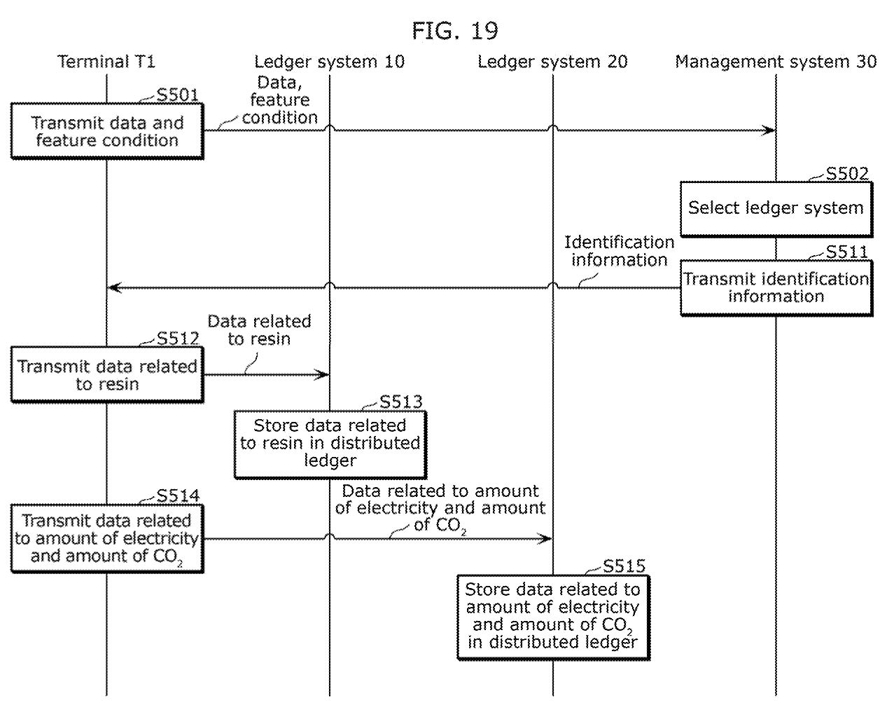

FIG. 19 is a sequence diagram illustrating a second example of the processing by information processing system 1 in a variation of the present embodiment. The processing illustrated in FIG. 19 is an example of processing executed by information processing system 1 in the case where management system 30 stores data in ledger system 10 or ledger system 20.

The processes of step S501 to step S502 illustrated in FIG. 19 are the same as the processes with the same names illustrated in FIG. 13.

In step S511, management system 30 transmits identification information indicating the ledger system specified in step S502 to terminal T1. The identification information transmitted by management system 30 contains identification information indicating ledger system 10 and identification information indicating ledger system 20. More specifically, the identification information transmitted by management system 30 contains the identification information indicating ledger system 10 as a ledger system in which data related to a resin is to be stored and contains the identification information indicating ledger system 20 as a ledger system in which data related to the amount of electricity and the amount of CO₂ is to be stored. Terminal T1 receives the transmitted identification information.

In step S512, terminal T1 transmits the data related to the resin to ledger system 10. Ledger system 10 receives the transmitted data related to the resin.

In step S513, ledger system 10 stores the data received in step S512 and related to the resin in distributed ledger 111.

In step S514, terminal T1 transmits the data related to the amount of electricity and the amount of CO₂ to ledger system 20. Ledger system 20 receives the transmitted data related to the amount of electricity and the amount of CO₂.

In step S515, ledger system 20 stores the data received in step S514 and related to the amount of electricity and the amount of CO₂ in distributed ledger 211.

At the time when the above steps S513 and S515 are completed, ledger system 10 (more specifically, distributed ledger 111) stores the data related to the resin. In addition, ledger system 20 (more specifically, distributed ledger 211) stores the data related to the amount of electricity and the amount of CO₂ (see FIG. 14).

Through the series of steps illustrated in FIG. 19, information processing system 1 can assist the user in storing data in ledger system 10 or ledger system 20, with management system 30.

### Description of Distributed Ledger Systems

Ledger system 10 and ledger system 20 in the above description (also referred to as a distributed ledger system) will be described in detail below.

The distributed ledger system is a system that stores and maintains information by means of a peer to peer (P2P) network technique for a plurality of nodes connected together. Each of the nodes is an information processing device in which a processor (e.g., a CPU) executes a program using a memory to perform predetermined processing.

In the distributed ledger system, the plurality of nodes maintain identical copies of information and continuously synchronize the information in an autonomous and distributed manner. This enables the distributed ledger system to store information appropriately while substantially preventing the information from being tampered with, without a privileged node (e.g., a centralized server or a server in a client-server model).

A device to access a distributed ledger is only required to access any one of the plurality of nodes included in the distributed ledger system. In other words, the device need not access a few devices such as centralized servers. Therefore, the concentration of a communication load or processing load on a centralized server, which can occur in a centralized system, is avoided. This produces such advantages that the resources of the nodes (the CPUs, the memories, etc.) are not required to have particularly high-performance specifications, and that communication lines to which the nodes are connected are not required to have particularly large communication capacities. This enables the distributed ledger system to be constituted by ordinary (or general-purpose) nodes or communication lines and can contribute to the effect of reducing necessary computer resources or communication resources or reducing the costs necessary for nodes or communication lines.

In addition, a distributed ledger system is capable of storing information with high fault tolerance or allowing information to be referred to with high fault tolerance. In general, a plurality of nodes included in a distributed ledger system are arranged to be physically or network-wise distributed. A distributed ledger system stops if a plurality of nodes included in the distributed ledger system all stop. However, it is rare for the distributed ledger system to stop because it is rare for all of the plurality of nodes physically or network-wise distributed to stop. This is considered to be an advantage over a centralized system, which can fail to store information or fail to allow information to be referred to when stopping.

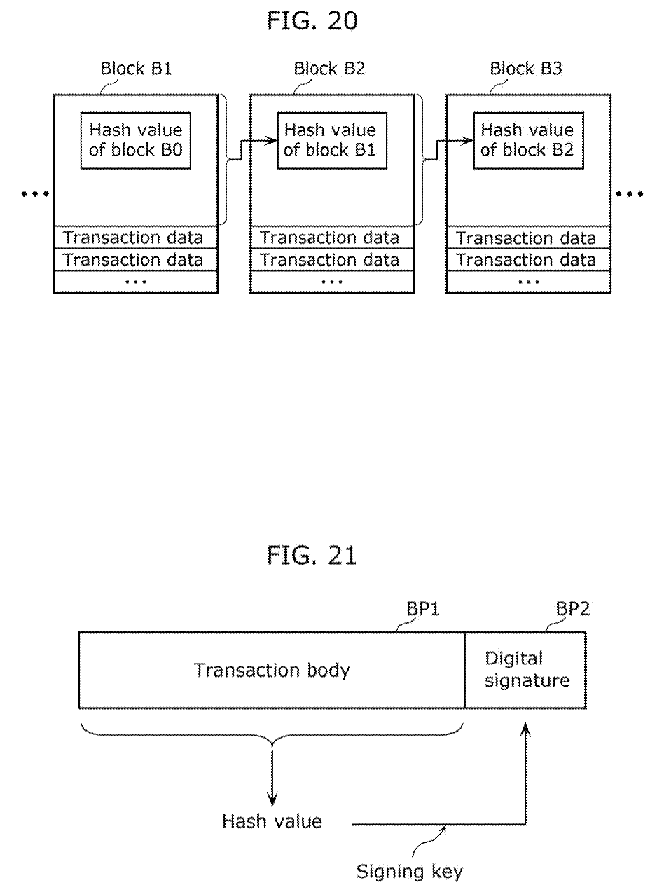

With reference to FIG. 20 to FIG. 24, the data structure of a distributed ledger, the execution of a smart contract, and the data structure of an NFT will be described.

FIG. 20 is an explanatory diagram illustrating the data structure of a blockchain, which is an example of the distributed ledger.

In the blockchain, blocks, which are recording units of the blockchain, are connected to form a chain. Each of the blocks includes a plurality of transaction data items and the hash value of its previous block.

FIG. 20 illustrates blocks B1, B2, and B3 included in the blockchain.

For example, block B2 includes the hash value of block B1, the previous block. The hash value of block B1 is a hash value calculated by computation performed on the content of block B1 according to a hash algorithm.

Block B3 includes a hash value calculated from the plurality of transaction data items included in block B2 and the hash value of block B1, as the hash value of block B2.

As seen from the above, the blockchain has the configuration in which the blocks each including the content of its previous block in the form of a hash value are connected to form a chain. Thus, the blockchain can effectively prevent tampering with recorded transaction data.

If past transaction data is altered (in other words, tampered with), the hash value of the block including the transaction data differs from the value before the alteration. In this case, in order to make the block including the altered transaction data appear authentic, it is necessary to rebuild all the blocks following the block, which includes the altered transaction data, in the distributed ledger stored in each of multiple servers. This task is extremely difficult in reality. These characteristics can make it substantially impossible to tamper with transaction data included in a blockchain.

Note that, to store transaction data in a blockchain, a node generates a block including the transaction data to be stored and executes processing based on a consensus algorithm for the generated block with the other nodes to reach a consensus with them. When the consensus is reached, the node performs control to store the block in the blockchain. In this manner, a plurality of nodes operating in an autonomous and distributed manner can connect a valid block to the blockchain. As the consensus algorithm, practical byzantine fault tolerance (PBFT) may be used, or proof of work (PoW), proof of stake (PoS), or the like may be used. Note that, in the case where Hyperledger fabric is used as an example of a distributed ledger technology, the consensus algorithm need not be executed.

FIG. 21 is an explanatory diagram illustrating the data structure of transaction data.

Transaction data illustrated in FIG. 21 includes transaction body BP1 and digital signature BP2 (will also be referred to simply as a signature). Transaction body BP1 is the data body included in the transaction data. Digital signature BP2 is generated by encrypting the hash value of transaction body BP1 with a signing key of the creator of the transaction data (in other words, a private key).

Using digital signature BP2 included in the transaction data, a node receiving the transaction data can verify whether transaction body BP1 is valid (in other words, it is not tampered with). This can make it substantially impossible to tamper with the data included in transaction body BP1. In addition, by storing the transaction data that has been successfully verified in a blockchain, it is possible to maintain the validity of the transaction data stored in the blockchain.

In the above-described manner, transaction data included in a blockchain are stored in the blockchain in such a manner that the transaction data are linked together using the hash values of the transaction data and hash values of blocks. As a result, the transaction data included in the blockchain are stored and maintained in a manner that is effectively tamper-proof. This is an advantage over a database or a distributed database in which a collection of data is simply stored.

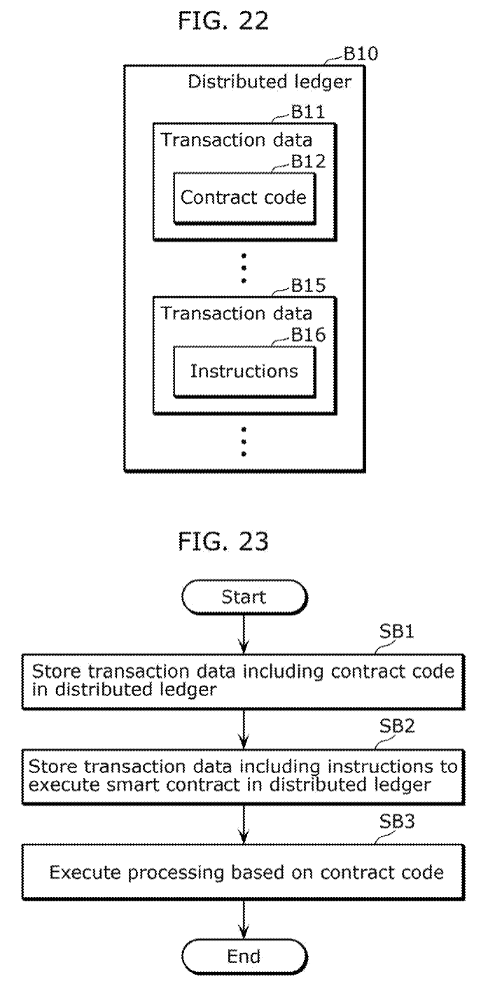

FIG. 22 is an explanatory diagram illustrating transaction data pertaining to the execution of a smart contract. FIG. 23 is an explanatory diagram illustrating processing pertaining to the execution of a smart contract.

With reference to FIG. 22 and FIG. 23, a series of steps pertaining to the execution of the smart contract using a distributed ledger will be described.

In step SB1, a node stores, in distributed ledger B10, transaction data B11 including contract code B12 in which the processing of the smart contract is written. For example, the node obtains transaction data B11 by receiving transaction data B11 from a certain information processing device through communication or by generating transaction data B11 by itself and stores obtained transaction data B11 in distributed ledger B10. Step SB1 is performed before the execution of the smart contract.

In step SB2, the node stores, in distributed ledger B10, transaction data B15 including instructions B16 to execute the smart contract. For example, the node receives transaction data B15 from a certain information processing device through communication and stores received transaction data B15 in distributed ledger B10.

In step SB3, in response to the storing of transaction data B15 including instructions B16 in distributed ledger B10 in step SB2, the node reads contract code B12 from distributed ledger B10 and executes the processing based on contract code B12. The result of the processing can be included in transaction data and stored in distributed ledger B10.

By the series of steps described above, upon receiving transaction data B15 including instructions B16 to execute the smart contract, the distributed ledger system executes the processing according to instructions B16 automatically (in other words, with no manual operations). Thus, it is possible to execute the processing with high efficiency (in other words, at high speed or in a short time). Achieving highly efficient processing brings about the effect of reduction in power consumption. In addition, dispensing with manual operations makes it possible to avoid the tampering of information or misconduct by a person, or human errors beforehand. Furthermore, since the result of the processing executed in such a manner is stored in a blockchain, it can be substantially impossible to tamper with the result of the processing.

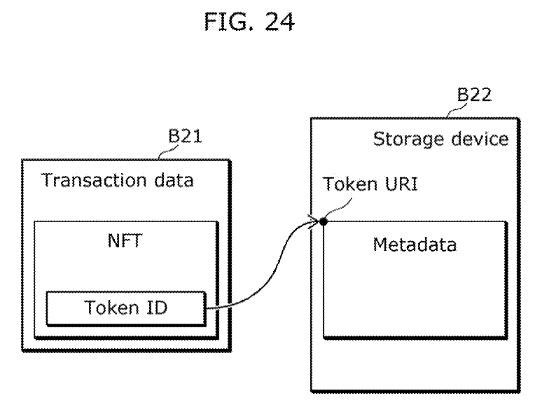

FIG. 24 is an explanatory diagram illustrating the structures of an NFT and metadata. The NFT is a token stored in a distributed ledger. The NFT is a unique token (in other words, a non-fungible token). The NFT is standardized according to, but not limited to, for example, Ethereum Request for Comments (ERC) 721. The NFT may conform to a standard different from ERC 721 or may be non-standard (e.g., specific to an organization). Note that although ERC721 is a standard for unique tokens, the NFTs described in the present Specification need not necessarily be unique tokens.

FIG. 24 illustrates transaction data B21 stored in a distributed ledger. Transaction data B21 stores an NFT. The NFT includes a token ID (i.e., identification information with which the NFT can be uniquely identified).

The NFT includes metadata. The metadata can be arranged at a location accessible over a network (e.g., storage device B22). A token URI indicating the location of the metadata is calculated from the token ID of the NFT and a predetermined base URI.

Information managed as the NFT may be included in transaction data B21 or may be included in the metadata. The inclusion of the information managed as the NFT in the metadata provides such an advantage that the amount of information included in transaction data B21 (in other words, information included in a blockchain) can be reduced. In this case, the metadata can be considered to contain the actual conditions of the information managed as the NFT. In the case where an image is managed in the form of an NFT, a URL indicating image data on the image can be managed as the NFT.

Note that each of the constituent elements in the embodiment described above may be configured in the form of an exclusive hardware product, or may be implemented by executing a software program suitable for the constituent element. Each of the constituent elements may be implemented by means of a program executor, such as a CPU or a processor, reading and executing the software program recorded on a recording medium such as a hard disk or a semiconductor memory. Here, the software program for implementing the information processing device and the related technologies according to the embodiment described above is such a program as described below.

That is, the program causes a computer to execute an information processing method to be executed by an information processing system, the information processing method including: obtaining feature information indicating a feature of each of a plurality of distributed ledger systems; obtaining data held by a user; obtaining a condition requested by the user as a condition that must be satisfied by, and is related to a feature of, a distributed ledger system in which the data is to be stored; selecting, from among the plurality of distributed ledger systems, one or more distributed ledger systems that satisfy the condition; and executing a storage process of storing, in the one or more distributed ledger systems selected, transaction data including the data.

Hereinbefore, an information processing method and the related technologies according to one or more aspects have been described based on an exemplary embodiment, but the present disclosure is not limited to this embodiment. Various modifications of the present embodiment as well as forms resulting from combinations of constituent elements in different embodiments that may be conceived by those skilled in the art may be included within the scope of one or more aspects so long as such modifications and forms do not depart from the essence of the present disclosure.

### INDUSTRIAL APPLICABILITY

The present disclosure is applicable to systems that include a plurality of distributed ledgers.

1. An information processing method to be executed by an information processing system, the information processing method comprising:
obtaining feature information indicating a feature of each of a plurality of distributed ledger systems;
obtaining data held by a user;
obtaining a condition requested by the user as a condition that must be satisfied by, and is related to a feature of, a distributed ledger system in which the data is to be stored;
selecting, from among the plurality of distributed ledger systems, one or more distributed ledger systems that satisfy the condition; and
executing a storage process of storing, in the one or more distributed ledger systems selected, transaction data including the data.

2. The information processing method according to claim 1, wherein
the condition includes a tamper-resistance condition that is a condition requested by the user as a condition related to an index indicating a degree of tamper resistance of the data stored in the distributed ledger system, and
in the selecting of the one or more distributed ledger systems that satisfy the condition:
for each of the plurality of distributed ledger systems, an index indicating a degree of tamper resistance of data stored in the distributed ledger system is calculated from the feature information obtained; and
one or more distributed ledger systems whose indices calculated satisfy at least the tamper-resistance condition are selected as the one or more distributed ledger systems.

3. The information processing method according to claim 2, wherein
the index increases with an increase in a total number of a plurality of information processing devices included in the distributed ledger system, or
the index increases with a decrease in a largest share of computational power among the plurality of information processing devices included in the distributed ledger system.

4. The information processing method according to claim 1, wherein
the condition includes a cost condition that is a condition requested by the user as a condition related to a cost required for storing the data in the distributed ledger system, and
in the selecting of the one or more distributed ledger systems that satisfy the condition:
for each of the plurality of distributed ledger systems, cost information indicating a cost required for storing the data in the distributed ledger system is calculated from the feature information obtained; and
one or more distributed ledger systems whose cost information calculated satisfies at least the cost condition are selected as the one or more distributed ledger systems.

5. The information processing method according to claim 1, wherein
the executing of the storage process includes:
generating transaction data including the data obtained, and storing the transaction data generated in the one or more distributed ledger systems selected.

6. The information processing method according to claim 5, wherein
the executing of the storage process further includes:
storing, in a storage device, identification information indicating the one or more distributed ledger systems selected, as identification information indicating the one or more distributed ledger systems in which the data is stored; and
outputting the identification information stored in the storage device, in response to receiving an identification request for identifying the one or more distributed ledger systems in which the data is stored.

7. The information processing method according to claim 1, wherein
the executing of the storage process includes:
providing identification information indicating, among the plurality of distributed ledger systems, a distributed ledger system in which the transaction data including the data obtained should be stored.

8. The information processing method according to claim 1, further comprising:
obtaining a data request;
obtaining, from a plurality of distributed ledgers included in the plurality of distributed ledger systems, one or more conforming data items that are one or more data items satisfying the data request obtained; and
providing the one or more conforming data items obtained.

9. The information processing method according to claim 8, wherein
in the obtaining of the one or more conforming data items, one or more data items that have already been provided by the user and stored in a distributed ledger and that satisfy the data request obtained are provided as the one or more conforming data items from the plurality of distributed ledgers included in the plurality of distributed ledger systems.

10. The information processing method according to claim 8, wherein
in the obtaining of the one or more conforming data items, (i) one or more data items that have already been provided by the user and stored in a distributed ledger and that satisfy the data request obtained or (ii) one or more data items that are related to data which has already been provided by the user and stored in a distributed ledger and that satisfy the data request obtained, are provided as the one or more conforming data items from the plurality of distributed ledgers included in the plurality of distributed ledger systems.

11. The information processing method according to claim 1, further comprising:
obtaining a data request;
obtaining, from a plurality of distributed ledgers included in the plurality of distributed ledger systems, one or more conforming data items that are one or more data items satisfying the data request obtained, and generating processed data by processing the one or more conforming data items obtained; and providing the processed data generated.

12. The information processing method according to claim 1, further comprising:
obtaining a data request; and
providing identification information indicating, among the plurality of distributed ledger systems, one or more distributed ledger systems that include one or more data items satisfying the data request obtained.

13. The information processing method according to claim 1, wherein
the information processing system that executes the information processing method is included in a terminal used by the user.

14. The information processing method according to claim 1, wherein
the information processing system that executes the information processing method is included in an information processing device that is included in the plurality of distributed ledger systems, the information processing device including a distributed ledger.

15. An information processing system comprising:
an obtainer that obtains feature information indicating a feature of each of a plurality of distributed ledger systems, obtains data held by a user, and obtains a condition requested by the user as a condition that must be satisfied by, and is related to a feature of, a distributed ledger system in which the data is to be stored;
a selector that selects, from among the plurality of distributed ledger systems, one or more distributed ledger systems that satisfy the condition; and
a storer that executes a storage process of storing, in the one or more distributed ledger systems selected, transaction data including the data.

16. A non-transitory computer-readable recording medium having recorded thereon a program for causing a computer to execute the information processing method according to claim 1.
